(19) United States
(12) Patent Application Publication
(10) Pub. No.: US 2005/0276311 A1
(43) Pub. Date: Dec. 15, 2005

(54) Mt-cdma using spreading codes with interference-free windows

(75) Inventors: Americo Brajal, Villeneuve Le Roi (FR); Berna Unal Sayrac, Paris (FR); Ludovic Lauer, Paris (FR); Celine Morlier, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Groenewoudseweg 1 (NL)

(21) Appl. No.: 10/518,276

(22) PCT Filed: Jun. 13, 2003
(86) PCT No.: PCT/IB03/02910

§ 371 Date: Dec. 16, 2004

(30) Foreign Application Priority Data
Jun. 25, 2002 (EP) 02291578.9

(51) Int. Cl. H04B 1/69

(52) U.S. Cl. 375/140; 375/260

(57) ABSTRACT

The invention relates to digital transmission. It particularly relates to a method of transmitting data using multi-carrier Code-division Multiple Access (CDMA) for accessing a transmission system. The method comprises a step of modulating the data to be transmitted using Orthogonal Frequency-division Multiplexing (OFDM) for producing OFDM modulated data symbols and a step of spreading the OFDM modulated data symbols with spreading codes including a set of predefined sequences, wherein the sequences are predefined so that they satisfy predetermined auto-correlation and/or cross-correlation criteria within a region around the zero-time offset of the correlation function, defined as an interference Free Window (IFW).

### FIELD OF THE INVENTION

The invention generally relates to digital transmission. In particular, it relates to a method of transmitting data using multi-carrier Code-Division Multiple Access (CDMA) for accessing a transmission system and to a method of receiving such transmitted data.

The invention also relates to a system, a transmitter and a receiver for carrying out the methods mentioned above.

It also relates to computer program products for carrying out such methods.

The invention applies particularly to future generation high data rate mobile communications systems (beyond 3^{rd} Generation).

### BACKGROUND ART

Due to the increasing demand for higher rate mobile data communications, partly because multimedia traffic is expected to dominate voice traffic in the near future, the next generation of cellular wireless systems, also called 4G systems, have the important challenge of providing high-capacity spectrum-efficient services to the customers. Therefore, even before the fall commercial deployment of 3G systems, studies and discussions on 4G systems (or IMT-2010+ systems) have already started. Efforts are being made to develop an air interface that supports the requirements of the increasing mobile data traffic.

Wideband Code-Division Multiple Access (CDMA) systems have recently been proposed for wireless communication networks. These systems provide higher capacity and higher data rates than conventional access techniques. Moreover, they are able to cope with the asynchronous nature of multimedia data traffic and to combat the hostile channel frequency selectivity. However, the large frequency bandwidth of such high-speed wireless links makes them susceptible to Intersymbol Interference (ISI). Therefore, a number of multi-carrier CDMA techniques have been suggested to improve performance over frequency selective channels. On the other hand, one of the ways to increase the user data rate in the access network is to use a multi-carrier multiplexing technique known as Orthogonal Frequency-Division Mutiplexing (OFDM). OFDM is a good solution to transmit high data rates in a mobile environment, even in a highly hostile radio channel. Multi-carrier CDMA (OFDM-CDMA) combines OFDM and CDMA techniques. It allows to benefit from the robustness against channel dispersivity of OFDM and from the high multiple access capacity of CDMA. Spreading is performed either in the frequency domain, leading to Multi-Carrier CDMA (MC-CDMA), or in the time domain, leading to Multi-Tone CDMA (MT-CDMA) and Multi-Carrier Direct Sequence CDMA (MC-DS-CDMA).

OFDM techniques suffer from various drawbacks: synchronization is difficult to perform and systems are sensitive to frequency offset and non-linear amplification resulting in high peak-to-average power ratio (PAPR). Though multi-carrier CDMA suffers from the same drawbacks, its major advantage is to lower the symbol rate in each sub-carrier allowing longer symbol duration and hence easier channel estimation.

The article, denoted [1], by L. Vandendorpe: “Multitone spread spectrum multiple access communications system in a multipath Rician fading channel,” published in IEEE Transactions on Vehicular Technology, vol. 44, no. 2, pages 327-337, May 1995, describes, for the uplink, the asynchronous Multi-Tone CDMA (MT-CDMA) technique as a promising candidate for future 4G systems. The main idea behind the structure of MT-CDMA is to be able to increase the spreading sequence length by the addition of multiple carriers without increasing the bandwidth, thus having the advantage of increasing the user capacity by decreasing the Multiple Access Interference (MAI). However, this advantage is achieved at the expense of an increase in Inter-Carrier Interference (ICI) which counterbalances the advantage, and thus, the increase in user capacity can be lost. Therefore, MT-CDMA systems require interference cancellation/reduction techniques that can have prohibitive complexities in high data rate wireless applications.

### SUMMARY OF THE INVENTION

It is an object of the invention to provide a system, which is less complex to implement than the one described in the cited article [1] and which yields a better quality.

The invention takes the following aspects into consideration. Large Area Synchronized-CDMA (LAS-CDMA) has recently been proposed to enhance 3G and 4G wireless systems and described in the document, denoted [2]: “Physical layer specification for LAS-2000,” in China Wireless Telecommunication Standards (CWTS), WG1, SWG2#4, LAS-CDMA Sub-Working Group, Apr. 25^{th} 2001. LAS-CDMA uses an efficient set of spreading codes, called LAS codes that have perfect autocorrelation and cross-correlation properties within a region around the origin defined as the Interference-Free Window (IFW). LAS codes are described in the article, denoted [3], by D. Li “A high spectrum efficient multiple access code,” published in Proceedings of the Fifth Asia-Pacific Conference on Communications and Fourth Optoelectronics and Communications Conference (APCC/OECC'99), vol. 1, pages 598-605, 1999, as a new class of high spectrum efficient multiple access codes. Similar sequences also exist in literature, such as e.g. Zero Correlation Zone (ZCZ) sequences described in the articles by P. Z. Fan, N. Suehiro and X. M. Deng “A class of binary sequences with zero correlation zone,” published in Electronics Letters, vol. 35, pages 777-779, 1999, denoted [4], or in the article by X. M. Deng and P. Z. Fan:“Spreading sequence sets with zero correlation zone,” in Electronics Letters, vol. 36, no. 12, pages 982-983, December 2000, denoted [5], Low Correlation Zone (LCZ) sequences described in the article by X. H. Tang, P. Z. Fan and S. Matsufuji: “Lower bounds on the maximum correlation of sequence set with low or zero correlation zone,” published in Electronics Letters, vol. 36, no. 6, pages 551-552, March 2000, denoted [6], or the article by B. Long, P. Zhang and J. Hu:“ A generalized QS-CDMA system and the design of new spreading codes,” in IEEE Transactions on Vehicular Technology, vol. 47, pages 1267-1275, November 1998, denoted [7], and Generalized Orthogonal Sequences described in the article by P. Fan and L. Hao: “Generalized orthogonal sequences and their applications in synchronous CDMA systems,” in IEICE Trans. Fundamentals, vol. E83-A, no. 11, pages 2054-2069, November 2000, denoted [8]. The common feature in these sequences is that the autocorrelation and cross-correlation properties satisfy the desired conditions only within a certain region centered on the origin. By using such sequences for spreading purposes in CDMA-based systems, it is then possible to obtain significant reductions in both the Intersymbol Interference (ISI) if the channel delay spread is smaller than the length of the ZCZ/LCZ, and the MM if the synchronization among users can be controlled to a permissible time difference that takes into account the length of the LCZ/ZCZ. For LAS codes, it has been shown that the product of the number of available codes by the length of the IFW is directly proportional to the sequence length. Thus, by having a longer sequence length, the number of available codes and/or the length of the IFW can be increased.

The invention proposes a new system, which can use one of the spreading sequence families mentioned above with the MT-CDMA structure. Using the interference rejection properties of these codes allows benefiting from the advantages of MT-CDMA without having to suffer from ICI. By using the possibility of increasing the spreading sequence length without bandwidth expansion provided by MT-CDMA, the number of available spreading codes and/or the length of the IFW can be increased. It is especially relevant to increase the length of the IFW because of the increasing channel length for high data rate wireless applications. Thus, the new system can be seen as a symbiosis where the two component systems enhance the relative performance of each other.

### BRIEF DESCRIPTION OF THE DRAWINGS

The invention and additional features, which may be optionally used to implement the invention to advantage, are apparent from and will be elucidated with reference to the drawings described hereinafter and wherein:

FIG. 1 is a conceptual block diagram illustrating an example of an MT-CDMA transmitter,

FIG. 2 is a schematic illustrating the spectrum of an MT-CDMA signal,

FIG. 3 is a conceptual block diagram illustrating an example of an MT-CDMA receiver,

FIG. 4 and FIG. 5 are schematics for illustrating the construction of an example of a spreading code, which can be used in the invention,

FIG. 6 and FIG. 7 are graphs illustrating simulation results in a system in accordance with the invention,

FIG. 8 is a conceptual block diagram illustrating an example of a system in accordance with the invention.

### DETAILED DESCRIPTION OF THE DRAWINGS

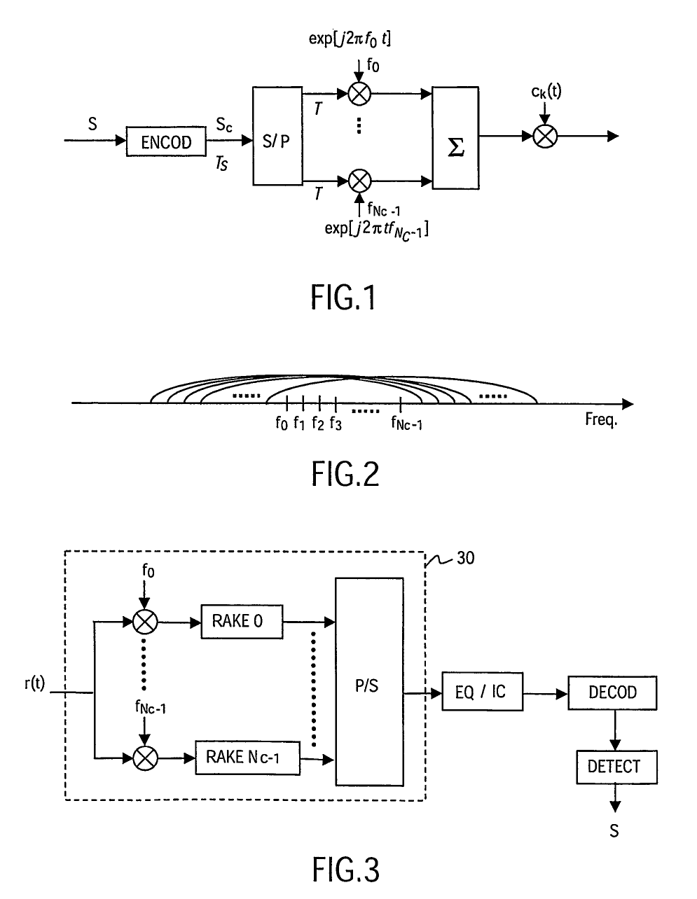

FIG. 1 shows an MT-CDMA transmitter. The MT-CDMA scheme is mainly proposed for the uplink communications of a cellular system due to its asynchronous structure. An encoder ENCOD encodes incoming data symbols S for an arbitrary user k into encoded data symbols Sc. A serial-to-parallel converter S/P converts the incoming encoded data symbols Sc into Nc low rate parallel sub-streams, each of which modulates a sub-carrier fₚ(p=0, . . . Nc−1), and are summed up to yield an OFDM symbol. The incoming encoded data symbol duration Ts is increased by the factor Nc to yield T=Nc×Ts as the OFDM symbol duration at the output of the adder. The OFDM symbol is then spread by the associated spreading waveform of user k, cₖ(t), and transmitted.

FIG. 2 shows the spectrum of an MT-CDMA signal comprising Nc sub-carriers denoted f₀, f₁, . . . , f_{Nc-1}. The sub-carrier spacing is 1/T, so the Nc parallel data sub-streams fulfill the orthogonality requirements before spreading. However, after spreading, the spectrum of each sub-carrier no longer satisfies the orthogonality condition, resulting in a major drawback of MT-CDMA systems: the Inter Carrier Interference (ICI), as illustrated by FIG. 2.

On the other hand, the tight sub-carrier spacing enables using longer spreading codes of length L, that is longer by a factor of Nc than the length of a conventional DS-CDMA scheme, making the processing gain of an MT-CDMA system being equal to L/Nc, which is a major advantage of the system. Therefore the trade-off in an MT-CDMA system is that, at the expense of higher ICI, the system benefits from the advantages of longer spreading sequences (like the reduction in MAI and ISI due to better correlation properties, having more available sequences, etc.). In a channel where these advantages are dominant, the MT-CDMA scheme can outperform the conventional DS-CDMA scheme.

FIG. 3 shows an MT-CDMA receiver. It comprises a RAKE demodulator 30, an equalizer, which also performs interference cancellation, denoted EQ/IC, a decoder DECOD and a detector DETECT. The receiver receives a signal formed by the MT-CDMA data sequences transmitted by the transmitter depicted in FIG. 1. The multi-carrier MT-CDMA signal, denoted r(t), is received by the RAKE demodulator 30. It comprises several sub-carrier signals distributed among Nc sub-carriers, denoted f₀ to f_{Nc-1}, and each sub-carrier signal having several paths called multi-paths. The RAKE demodulator first separates the sub-carriers to demodulate the received signal, i.e. to perform the reverse operation to the classical OFDM modulation. To this end, parallel multipliers multiply the received signal r(t) by the sub-carriers f₀ to f_{N-1}. Then, Nc RAKE combiners, denoted RAKE 0 to RAKE Nc−1, perform matched filtering on all received paths, and combine them optimally by Maximum Ratio Combining. Each branch in the RAKE demodulator 30 of the receiver front-end can be regarded as a standard CDMA RAKE combiner tuned to the associated sub-carrier. A parallel-to-serial converter P/S converts the parallel outputs of the RAKE combiners into serial sequences. The serial sequences are then equalized and residual interference is cancelled with the equalization/interference cancellation block EQ/IC. Then the sequences are decoded by the decoder DECOD which performs a reverse operation to the encoder ENCOD depicted in FIG. 1. Then the detector DETECT decides with an estimation of the received signal to retrieve the original data S.

Since the performance of the RAKE receiver is interference-limited (determined by the correlation properties of the spreading sequence set), post-RAKE processing in terms of equalization (EQ), Interference Cancellation (IC) and/or Multi-User Detection (MUD) is usually necessary for satisfactory performance. For high data rate wireless applications of the next generation cellular mobile systems, this necessity can bring complexity problems. Furthermore, it has been shown that the overall digital low-pass equivalent structure between the serial to parallel converted coded symbols and the samples at the output of the RAKE combiners conveys a Multiple Input Multiple Output (MIMO) structure. Therefore, the post-RAKE processing also has a MIMO structure, which further makes it prone to complexity problems.

The low-pass equivalent transmitted signal xₖ(t) at the output of the transmitter of FIG. 1 is given by:

$${x}_{k} ( t ) = \sqrt{\frac{P}{{N}_{C}}} {\sum }_{q = 0}^{{N}_{c} - 1} {\sum }_{n = - ∞}^{∞} {I}_{k}^{q} [ m ] {c}_{k} ( t ) u ( t - nT ) exp ( j \frac{2 π}{T} qt ) \qquad ( 1 )$$

where P is the transmit power of all users, Iₖ^{q}[m] is the complex symbol on sub-carrier q of user k at instant m, cₖ(t) is the spreading waveform of user k, and u(t) is the OFDM pulse shape which is assumed to be rectangular with unit amplitude and duration T. The RF frequency associated with sub-carrier q is f_{q}=f₀+q/T where f₀ is some base frequency.

Assuming a linear time-invariant channel of user k with low-pass impulse response gₖ(t), the received low-pass equivalent signal r(t) in a system with K users can be expressed as:

$$r ( t ) = \sqrt{\frac{P}{{N}_{C}}} {\sum }_{k = 1}^{K} {\sum }_{q = 0}^{{N}_{c} - 1} {\sum }_{n = - ∞}^{∞} {I}_{k}^{q} [ m ] {h}_{k}^{q} ( t - mT ) + n ( t ) \qquad ( 2 )$$

where hₖ^{q}(t)=[cₖ(t) u(t) expo 2π/Tx qt)]*gₖ(t), * denotes linear convolution and n(t) is the zero-mean Additive White Gaussian Noise (AWGN) with two-sided power spectral density N₀. The receiver of user u employs a RAKE front-end with Maximal Ratio Combining (MRC) whose outputs are obtained by:

$${y}_{u}^{p} [ n ] = \frac{1}{T \sqrt{P}} {\int }_{- ∞}^{+ ∞} r ( t ) [ {h}_{u}^{p} ( t - nT ) ] * ⅆ t \qquad ( 3 )$$

where yᵤ^{p}[n] is the RAKE-MRC output of user u associated with sub-carrier p at time instant n, and (.)* denotes complex conjugate. Elaborating more on the RAKE-MRC outputs, we obtain:

$${y}_{u}^{p} [ n ] = \frac{1}{\sqrt{{N}_{c}}} \{ \begin{matrix}{I}_{u}^{p} [ n ] {χ}_{uu}^{pp} [ 0 ] + {\sum }_{\begin{matrix}η = - ∞ \\ ( η \neq 0 )\end{matrix}}^{∞} {I}_{u}^{p} [ n - η ] {χ}_{uu}^{pp} [ η ] + \\ {\sum }_{\begin{matrix}q = 0 \\ ( q \neq p )\end{matrix}}^{{N}_{c} - 1} {\sum }_{η = - ∞}^{∞} {I}_{u}^{p} [ n - η ] {χ}_{uu}^{pp} [ η ] + {\sum }_{\begin{matrix}k = 1 \\ ( q \neq p )\end{matrix}}^{K} {\sum }_{q = 0}^{{N}_{c} - 1} {\sum }_{η = - ∞}^{∞} {I}_{u}^{p} [ n - η ] {χ}_{uu}^{pp} [ η ]\end{matrix} \} + \frac{1}{T \sqrt{P}} {v}_{u}^{p} [ n ] \qquad ( 4 )$$

where the channel correlation coefficients χᵤₖ^{pq} are defined as:

$${χ}_{uk}^{pq} [ η ] = \frac{1}{T} {\int }_{- ∞}^{+ ∞} {h}_{k}^{q} ( t ) [ {h}_{u}^{p} ( t - η T ) ] * ⅆ t \qquad ( 5 )$$

and νᵤ^{p}[n] is the zero-mean AWGN sample with variance N₀Tχᵤᵤ^{PP}[0]. The first term in equation (4) is the desired signal term, the second is the ISI term, the third is the ICI term, and the fourth is the MAI term. In all these interference terms, only L_{c} components of each summation are significant. L_{c} is called the channel depth and is given by L_{c}=└1+Tₘ/T┘ where Tₘ is the multi-path delay spread of the channel and where └.┘ means rounding to the closest smaller integer. Considering the generic multi-path channel model of user k as:

$${g}_{k} ( t ) = {\sum }_{l = 0}^{{L}_{c} - 1} {g}_{k , l} δ ( t - {τ}_{k , l} ) \qquad ( 6 )$$

where {g_{k,l}} and {τ_{k,l}} denote the complex path coefficients and path delays, respectively, equation (5) can be rewritten as:

$${χ}_{uk}^{pq} [ η ] = \frac{1}{T} {\sum }_{t = 0}^{Lc - 1} {\sum }_{i = 0}^{Lc - 1} {g}_{k , l} {g}_{u , l}^{*} exp ( j2 \frac{π}{T} ( p {τ}_{u , t} - q {τ}_{k , i} ) ) {R}_{uk}^{pq} [ η ] \qquad ( 7 )$$

where the correlation coefficients Rᵤₖ^{pq}[η] are given by:

$${R}_{uk}^{pq} [ η ] = {\int }_{- ∞}^{∞} {c}_{u}^{*} ( t - {τ}_{u , l} ) {c}_{k} ( t - {τ}_{k , i} ) u ( t - η T - {τ}_{u , l} ) u ( t - {τ}_{k , i} ) exp [ j2 \frac{π}{T} ( q - p ) t ] ⅆ t \qquad ( 8 )$$

The correlation coefficients depend on the partial correlation properties of the spreading sequences. As observed from the above equations, MT-CDMA trades off the reduction in correlation values due to utilization of longer spreading codes by the extra interference coming from the introduction of more sub-carriers.

CDMA systems with single user detection are interference-limited. The interference in CDMA systems is determined by the autocorrelation and cross-correlation properties of the spreading codes. An ideal code set has no side lobes in their aperiodic/partial autocorrelations (zero off-peak autocorrelation) and cross-correlations (zero cross-correlation) as described in [3]. However, having ideal autocorrelation and cross-correlation properties are contradicting goals, and no such code set exists. Fortunately, in order to reject interference, it is not necessary to have zero off-peak autocorrelation and zero cross-correlation everywhere, but within a certain region around the origin whose length depends on the channel delay spread, which is defined as a time length corresponding to an estimate of a difference between the time lengths of at least two different multi-paths, generally the longest and the shortest. So, as long as synchronism can be established that takes into account the channel delay spread, a CDMA system using such spreading codes does not suffer from interference. Spreading code sets satisfying these properties (also called generalized orthogonality conditions) exist in literature [4] to [8].

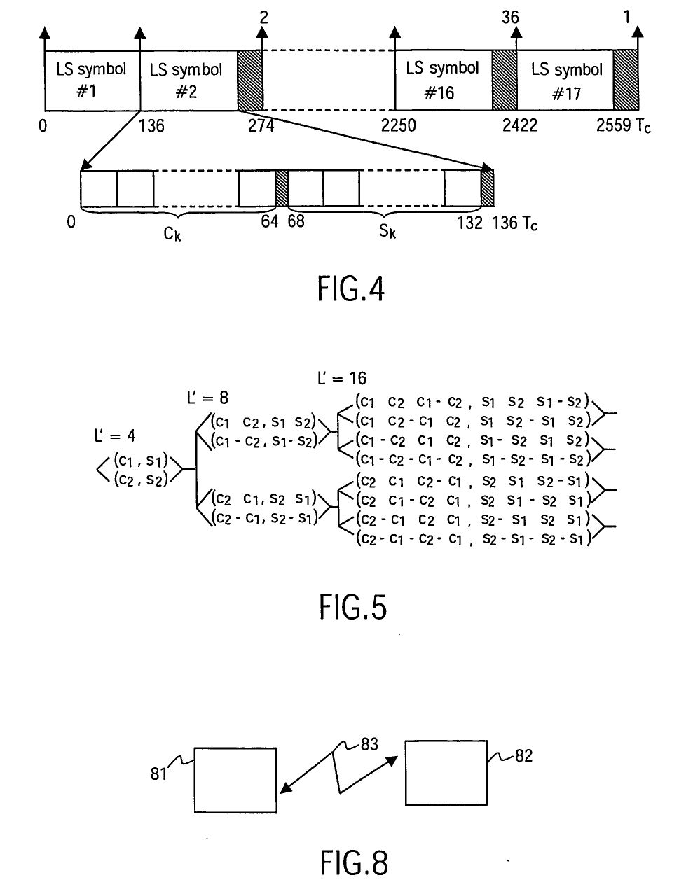

FIG. 4 and FIG. 5 show the construction of an example of these codes, denoted LAS code, which has the desired interference rejection properties. These codes were recently used in a new CDMA scheme called LAS-CDMA that has been proposed for the 3G standardization process in China, and also as a basis for 4G systems. LAS-CDMA uses this specific set of spreading codes, called LAS codes, whose off-peak partial autocorrelation and partial cross-correlation values are zero within a region around the origin [-d,d]: the Interference Free Window, as described in [3]. In order to achieve these partial autocorrelation and cross-correlation properties, zero gaps are inserted in the sequence. LAS codes are the combination of the pulse-suppressing bipolar LS codes, and the LA pulses that determine the lengths and the places of the zero gaps. Between two LA pulses, there is an LS code that comprises a C section Cₖ and an S section Sₖ followed by an C gap and an S gap, respectively, as shown in FIG. 4. LA pulses are represented in FIG. 4 by hatched blocks inserted between the LS blocks. Hatched blocks in the frame illustrating the details of an LS symbol represent S and C gaps, respectively.

FIG. 5 shows the iterative construction of the C and S sections, which are bipolar sequences where L′ is the length of the LS sequence without the zero gap (i.e. the sum of the lengths of Cₖ and Sₖ). As an example for a LAS code: c1=++, c2=+−, s1=−+ and s2=−−at the first level where L′=4. As for the LA codes, they are used to identify a cell/sector, and different LA codes are obtained by permuting the basic LA code whose pulse positions are depicted in table 1 below.

TABLE 1

| | Primary LA code pulse position | | | | | | | | | | | | | | | | |
|---|---|---|---|---|---|---|---|---|---|---|---|---|---|---|---|---|---|
| LA gap | 0 | 2 | 4 | 6 | 8 | 10 | 12 | 14 | 16 | 18 | 20 | 22 | 24 | 26 | 28 | 36 | 1 |
| LA pulse | 136 | 274 | 414 | 556 | 700 | 846 | 994 | 1144 | 1296 | 1450 | 1606 | 1764 | 1924 | 2086 | 2250 | 2422 | 2259 |
| position | | | | | | | | | | | | | | | | | |

The construction of a LAS code shown in FIG. 4 is an example, which corresponds to the Chinese 3G standard specification proposal [2]. The C and S sections of the LS code are of length 64 (forming an LS code of length L′=128), the length of the C and S gaps is 4, the number of LA pulses is 17, and the total number of chips found in the LAS code is 2559. With these parameters, the constructed code has an IFW of length 9, i.e. d=4. Further details on the construction of LAS codes are given in the document [2].

LAS codes have certain drawbacks: the insertion of zeros in the sequence causes a loss in spectral efficiency, and the number of sequences satisfying the generalized orthogonality conditions is limited. It has been shown that the upper bound on the number of such available sequences is given by L′/(d+1). So, in order to increase the number of available sequences, the sequence length would have to be increased, which would result in bandwidth expansion and/or the IFW size would have to be decreased, which would result in an increase of interference.

Using LAS-CDMA in MT-CDMA leads to a new system denoted LAS-MT-CDMA, in accordance with the invention. This new system brings with it a symbiosis, which benefits from the advantages of both systems without suffering from all the drawbacks. In other words, the advantages of one system help to overcome the drawbacks of the other, and vice versa. By using LAS codes in MT-CDMA systems, the impact of ICI, ISI and MAI on system performance can be decreased. Considering equations (4), (7) and (8), the weight of the interference terms in the RAKE-MRC outputs will decrease due to the decrease in the correlation coefficients.

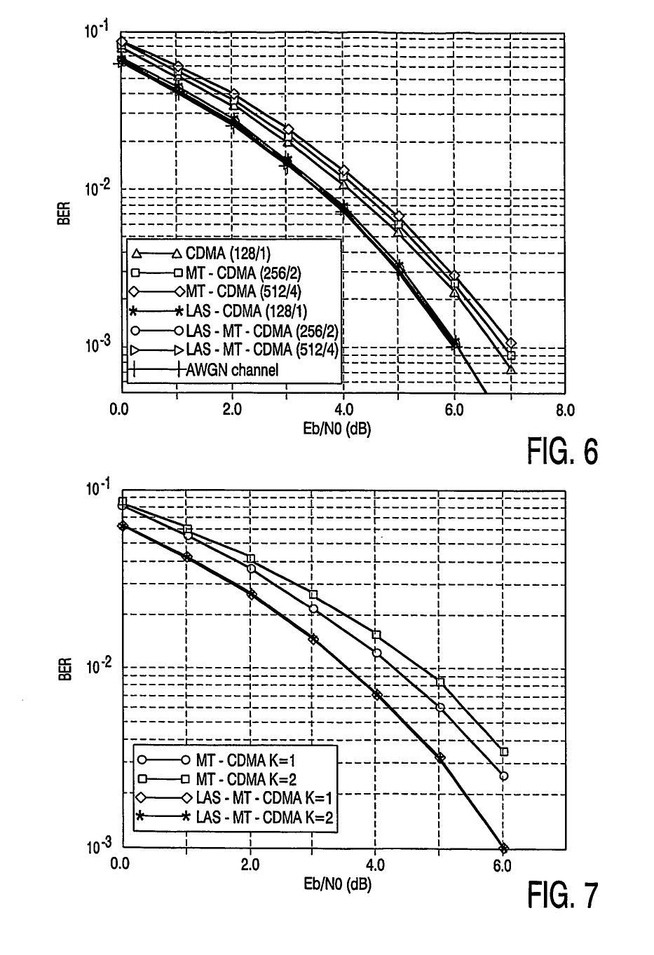

FIG. 6 and FIG. 7 show computer simulation results in order to be able to see the respective effects of increasing the number of sub-carriers in MT-CDMA and in LAS-MT-CDMA. FIG. 6 depicts the simulation results of both systems for one user with an increasing number of sub-carriers: Nc=1, Nc=2 and Nc=4. The curves represent the bit error rate BER with respect to the energy per bit over spectral density of noise Eb/No. MT-CDMA system employs extended Gold sequences. In all simulations, a static 2-tap EQ channel with a delay spread of 2Tc is used. The modulation scheme is QPSK. In order to keep the bandwidth equal for Nc=1, Nc=2 and Nc=4, spreading sequences of length 128, 256 and 512 are used respectively. The receiver consists of a two-finger RAKE receiver with MRC followed by a hard decision device. There is no equalizer, no interference canceller and no coding. Perfect channel state information is assumed. For comparison purposes, the performance on AWGN channel is also depicted in the same figure.

It can be observed from the simulation results that the MT-CDMA scheme suffers from extra interference with the addition of more sub-carriers. It means that the correlation properties of the extended Gold sequences cannot overcome the detrimental effects of the additional ICI introduced by the sub-carriers. However, this is not the case for LAS-MT-CDMA, wherein the addition of more sub-carriers does not introduce additional ICI thanks to the IFW (whose length is greater than the channel delay spread), so the performance degradation is avoided. It can also be observed that the performance of LAS-MT-CDMA on a 2-tap EQ channel is the same with the AWGN channel, which proves the efficiency of LAS codes. By looking at the correlation properties of LAS codes it can be said that even if the length of the IFW is smaller than the channel delay spread, the amount of introduced interference is still smaller compared to MT-CDMA.

The performance of LAS-MT-CDMA scheme with two different numbers of users is illustrated in FIG. 7. It gives comparative simulation results of MT-CDMA and LAS-MT-CDMA with a single user K=1 and with two users K=2. In this second set of simulations, the same channel and system models, modulation scheme and receiver structure are employed. The synchronism between different users stays within 2Tc. As can be observed from the Figure, addition of more users causes performance degradation in MT-CDMA due to the imperfect correlation properties of the extended Gold sequences. However, this is not the case in LAS-MT-CDMA, as long as synchronism between users can be maintained to a certain extent that takes into account the channel delay spread and the length of the IFW, addition of more users does not introduce MAI and the system performance does not degrade in LAS-MT-CDMA. With these simulation parameters, the number of users can be increased to 16 (the number of available sequences) without introducing MAI. This means that it is possible to avoid the “near-far effect” without having to implement the relatively complex MUD algorithms. Note that, due to the insertion of zeros, LAS-MT-CDMA has lower spectral efficiency than MT-CDMA (about 17%). In order to compare the two systems with the same spectral efficiency, coding can be introduced.

LAS-MT-CDMA is also advantageous when compared to LAS-CDMA. By using multiple sub-carriers in a LAS-CDMA system, the number of available sequences and/or the IFW size (both of which have the effect of increasing system capacity) can be increased by increasing the sequence length without bandwidth expansion. Increasing the IFW size is especially important when considering the longer channel length due to high data rates in wireless channels. For example, the LAS-CDMA specification uses a single carrier (Nc=1) with a code of length L′=128. With an IFW of d=4, the number of available sequences is 16. If we use two carriers (Nc=2), keeping the same user data rate and transmission bandwidth, we can use sequences of length L′=256 in the LAS-MT-CDMA scheme. With the same IFW as before (d=4), the number of available sequences can be increased up to 32. This means a twofold capacity increase, because the performance of the two systems is the same due to the total interference rejection capability of LAS codes. Alternatively, keeping the number of available sequences at 16, it is possible to design LAS codes having an IFW with d=8. This means that the system can support twice the data rate that can be supported by LAS-CDMA. Since the meaningful figure of merit for a multiple access system is its total spectral efficiency that is defined in terms of the total data throughput per sector per system bandwidth, increasing the average data rate twice for all users means doubling the spectral efficiency. Considering the demands of 4G systems in terms of spectral efficiency, this improvement is especially significant.

FIG. 8 shows a system in accordance with the invention, comprising a transmitter 81, a receiver 82 and a transmission channel 83 for transmitting data from the transmitter to the receiver. In a mobile communication system, for example, the user equipment would be the receiver and the base station the transmitter during a downlink transmission, whereas in an uplink transmission, the base station would be the receiver and the user equipment the transmitter. The transmitter is similar in design to the MT-CDMA transmitter depicted in FIG. 1, except that the spreading codes used have specific interference rejecting properties (e.g. LAS codes) as defined with reference to FIGS. 4 and 5, i.e. they satisfy predetermined auto-correlation and/or cross-correlation criteria within a region around the origin, defined as an Interference-Free Window (IFW). The data to be transmitted are modulated using Orthogonal Frequency-Division Multiplexing (OFDM) before being spread with these specific codes. The receiver is similar in design to the one depicted in FIG. 3, except the received sequences are spread by one of the spreading codes mentioned.

In conclusion, a new system has been described, which advantageously benefits from the interference rejection properties of judiciously selected spreading codes with the capability of MT-CDMA to increase the spreading sequence length without expanding the bandwidth. Moreover, this allows enhancing and extending the advantages brought by both systems without suffering from their drawbacks. The interference introduced by multiple sub-carriers are rejected by the selected spreading codes and, with the addition of multiple sub-carriers, increasing the sequence length can increase the efficiency of the spreading codes. Simulation results have shown that addition of multiple sub-carriers and users does not deteriorate the system performance, and leads to a capacity increase. Last but not least, the loss in spectral efficiency of certain of these spreading codes, notably the LAS codes, due to the insertion of zero gaps, which is a drawback, can be overcome by the use of other similar sequences in literature that do not require insertion of zero gaps e.g. ZCZ/LCZ sequences. It is also possible to compensate for this loss by appropriate channel coding.

The drawings and their descriptions hereinbefore illustrate rather than limit the invention. It will be evident that there are numerous alternatives, which fall within the scope of the appended claims. In this respect, the following closing remarks are made.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software, or both carries out a function.

Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps. Documents referred to:
[1]: L. Vandendorpe: “Multitone spread spectrum multiple access communications system in a multipath Rician fading channel,” published in IEEE Transactions on Vehicular Technology, vol. 44, no. 2, pages 327-337, May 1995.
[2]: “Physical layer specification for LAS-2000,” in China Wireless Telecommunication Standards (CWTS), WG1, SWG2#4, LAS-CDMA Sub-Working Group, Apr. 25^{th} 2001.
[3]: D. Li:“A high spectrum efficient multiple access code,” published in Proceedings of the Fifth Asia-Pacific Conference on Communications and Fourth Optoelectronics and Communications Conference (APCC/OECC'99), vol. 1, pages 598-605, 1999.
[4]: P. Z. Fan, N. Suehiro and X. M. Deng:“A class of binary sequences with zero correlation zone,” published in Electronics Letters, vol. 35, pages 777-779, 1999. [5]: X. M. Deng and P. Z. Fan:“Spreading sequence sets with zero correlation zone,” in Electronics Letters, vol. 36, no. 12, pp. 982-983, December 2000.
[6]: X. H. Tang, P. Z. Fan and S. Matsufuji: “Lower bounds on the maximum correlation of sequence set with low or zero correlation zone,” published in Electronics Letters, vol. 36, no. 6, pages 551-552, March 2000.
[7]: B. Long, P. Zhang and J. Hu:“ A generalized QS-CDMA system and the design of new spreading codes,” in IEEE Transactions on Vehicular Technology, vol. 47, pages 1267-1275, November 1998.
[8]: P. Fan and L. Hao: “Generalized orthogonal sequences and their applications in synchronous CDMA systems,” in IEICE Trans. Fundamentals, vol. E83-A, no. 11, pages 2054-2069, November 2000.

1. A method of transmitting data using multi-carrier Code-Division Multiple Access (CDMA) for accessing a transmission system, the method comprising a step of modulating the data to be transmitted using Orthogonal Frequency-Division Multiplexing (OFDM) for producing OFDM modulated data symbols and a step of spreading the OFDM modulated data symbols with spreading codes including a set of predefined sequences wherein the sequences are predefined so that they satisfy predetermined auto-correlation and/or cross-correlation criteria within a region around the origin, defined as an Interference-Free Window (IFW).

2. A method as claimed in claim 1, wherein the transmission system comprises a transmitter, a receiver and a transmission channel, for transmitting the data from the transmitter to the receiver via the transmission channel, the transmission channel including a set of multi-paths with associated time lengths, the transmission channel having a channel delay spread defined as a time length corresponding to an estimate of a difference between the time lengths of at least two different multi-paths, the length of the Interference-Free Window (IFW) depending on the channel delay spread.

3. A method as claimed in claim 1, wherein the sequences are such that their off-peak partial autocorrelation and partial cross-correlation values are zero within the Interference-Free Window (IFW).

4. A method as claimed in claim 2, wherein the sequences are such that they comprise zero gaps.

5. A transmitter for transmitting data using multi-carrier Code-Division Multiple Access (CDMA) for accessing a transmission system, comprising a modulator for modulating the data to be transmitted using Orthogonal Frequency-Division Multiplexing (OFDM) for producing OFDM modulated data symbols and a mixer for spreading the OFDM modulated data symbols with spreading codes including a set of predefined sequences, wherein the sequences are predefined so that they satisfy predetermined auto-correlation and/or cross-correlation criteria within a region around the origin, defined as an Interference-Free Window (IFW).

6. A method of receiving multi-carrier data sequences transmitted via a transmission system using multi-carrier Code-Division Multiple Access (CDMA) for accessing the transmission system, the data sequences being OFDM modulated before being spread with a set of predefined sequences satisfying predetermined auto-correlation and/or cross-correlation criteria within a region around the origin, defined as an Interference Free Window (IFW), the method comprising a step of demodulating the received multi-carrier data sequences with respect to a predefined set of sub-carriers and to the set of predefined data sequences.

7. A receiver for receiving data sequences transmitted via a transmission system using multi-carrier Code-Division Multiple Access (CDMA) for accessing the transmission system, the data sequences being OFDM modulated before being spread with a set of predefined sequences satisfying predetermined auto-correlation and/or cross-correlation criteria within a region around the origin, defined as an Interference-Free Window (IFW), the receiver comprising a set of rake combiners tuned to associated sub-carriers for demodulating the received data sequences.

8. A computer program product for a transmitter computing a set of instructions, which when loaded in the receiver, causes the receiver to carry out the method as claimed in claim 1.

9. A computer program product for a receiver computing a set of instructions, which when loaded in the receiver, causes the receiver to carry out the method as claimed in claim 6.

10. A system comprising at least a transmitter and a receiver for transmitting data from the transmitter to the receiver using multi-carrier Code-Division Multiple Access (CDMA) for enabling the transmitter to access the transmission system, the data to be transmitted being modulated using Orthogonal Frequency-Division Multiplexing (OFDM) before being spread with a set of predefined sequences wherein the sequences are predefined so that they satisfy predetermined auto-correlation and/or cross-correlation criteria within a region around the origin, defined as an Interference-Free Window (IFW).
